(19) United States
(12) Patent Application Publication
(10) Pub. No.: US 2026/0228054 A1
(43) Pub. Date: Aug. 6, 2026

(54) DYNAMIC LOAD BALANCING FOR DATA PROCESSING SYSTEMS

(71) Applicant: Dell Products L.P., Round Rock, TX (US)

(72) Inventors: GOVINDASAMY CHINNU, Bengaluru (IN); VIVEKANANDH NARAYANASAMY RAJAGOPALAN, Bangalore (IN); RAMJI RAMAGOPALAN, Bengaluru (IN)

(21) Appl. No.: 19/043,659

(22) Filed: Feb. 3, 2025

(51) Int. Cl. G06F 9/50

(52) U.S. Cl. CPC G06F 9/505

(57) ABSTRACT

Methods and systems for managing service systems are disclosed. An occurrence of a future event for a primary system of the service systems may be predicted. The occurrence of the future event may be likely to reduce a quality of services provided by the primary system at a future point in time. Based on the predicting of the occurrence and prior to the future point in time, computing resources of a secondary system of the service systems may be allocated. A new load balancing policy for the service systems may be obtained and staged with a load balancer of the service systems. Based on a determination that the occurrence of the future event is imminent, the new load balancing policy may be enforced to cause the at least a secondary system to participate in provisioning of the services.

### FIELD

Embodiments disclosed herein relate generally to managing data processing systems. More particularly, embodiments disclosed herein relate to systems and methods to manage load balancing for the data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a distributed system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing data processing systems that may provide computer-implemented services. For example, service systems (e.g., data processing systems) may provide at least a portion of the (computer-implemented) services to downstream consumers of the services (e.g., users, other data processing systems). To provide the services, the service systems may service incoming requests from the downstream consumers, which may trigger performance of workloads by the service systems, placing loads on the service systems. For example, system load may refer to a demand on a service system (e.g., a number of service requests per unit time), a number of tasks executed by hardware resources of the service system per unit time, a magnitude of traffic on a network that services the service system, and/or any combination thereof.

The load on a system may affect performance of the service system, thereby impacting the provided services. For example, if a service system is overloaded with requests (e.g., if the hardware resources of the service system are insufficient for servicing increasing volumes of workloads in an expected period of time), then a portion of the request may be rejected (e.g., may not be serviced), and the services provided by the service system may be of reduced quality.

To avoid overloading a single service system, a load balancer may distribute workloads among multiple service systems based on a predetermined (e.g., static) configuration. For example, the configuration may be based on different load balancing strategies such as: routing a request to a service system nearest to an origin of the request, even distribution of workloads (e.g., requests) across each service system, and/or routing requests based on a failed service system. However, the load placed on different service systems may vary over time due to changing conditions (e.g., changes in demand for different types of computer-implemented services, changes in availability of hardware resources due to failure and/or degradation); therefore a static load balancing configuration may be insufficient for managing load balancing over time.

To manage balancing loads for the service systems in view of changing conditions, load balancing configurations may be updated dynamically based on real-time conditions (e.g., real-time service demands, real-time system performance) using load balancing policies. For example, a primary system tasked with servicing requests for a computer-implemented service may become overloaded with requests for a period of time, and therefore an updated load balancing policy may be enforced to reroute a portion of the requests to a secondary system for servicing to reduce the load on the primary system for the period of time.

However, lead times for enforcing the load balancing policy may prevent timely rerouting of requests to the secondary system, causing the primary system to be overloaded for at least the period of time. For example, prior to rerouting the requests, computing resources of the secondary systems must be planned and allocated (e.g., identified, freed, and/or reserved), and the load balancing policy must be updated in accordance with the newly allocated resources. Therefore, the provided computer-implemented services may be of reduced quality for at least the period of time and/or until appropriate computing resources are planned for, allocated, and the updated load balancing policy is enforced.

Thus, to increase a likelihood of the service systems providing expected quality computer-implemented services over time in view of changing conditions, load balancing may be managed dynamically and proactively. To do so, a management system may predict occurrences of future events that may be likely to reduce the quality of the computer-implemented services provided by the service systems at future points in time. Based on the predictions and prior to the future points in time, computing resources for contribution toward the computer-implemented services may be allocated and new load balancing policies may be staged with the load balancer. Thus, when the future events are identified as imminent, the new load balancing policies may be enforced timely using the pre-allocated computing resources.

By doing so, delays associated with changes in load balancing policies (e.g., resource allocation) may be reduced, and the service systems may be more likely to provide expected quality computer-implemented services, despite the occurrences of the future events (e.g., changes in conditions) over time.

In an embodiment, a method for managing service systems is provided. The method may include predicting an occurrence of a future event for a primary system of the service systems, the occurrence of the future event being likely to reduce a quality of computer-implemented services provided by the primary system at a future point in time.

The method may also include, based on the predicting of the occurrence and prior to the future point in time: initiating allocation of computing resources of at least a secondary system of the service systems for contribution toward the computer-implemented services, the initiation of the allocation starting at a point in time likely to result in the computing resources being allocated prior to the future point in time; obtaining a new load balancing policy for the service systems based, in part, on the computing resources; staging the new load balancing policy with a load balancer of the service systems; making a determination that the occurrence of the future event is imminent; and, initiating, based on the determination, enforcement of the new load balancing policy to cause the at least a secondary system to participate in provisioning of the computer-implemented services.

Prior to initiating enforcement of the new load balancing policy, an existing load balancing policy may be used by the load balancer to assign requests for the computer-implemented services for servicing by the service systems, and the existing load balancing policy may not take into account the computing resources. The new load balancing policy may take into account the computing resources to ensure that the computing resources are used in the provisioning of the computer-implemented services once the new load balancing policy is enforced.

Predicting the occurrence may include using an inference model to obtain a prediction of at least one selected from a group consisting of: changes in demand for the computer-implemented services over time; and, changes in availability of computing resources of the service systems for provisioning of the computer-implemented services over time.

Making the determination may include: monitoring operation of at least a portion of the service systems leading up to the future point in time; comparing the operation to the prediction to identify a level of accuracy of the prediction; and, in an instance of the comparing where the level of accuracy meets criteria, identifying that a current time is within a threshold duration of time to the future point in time.

Initiating allocation of the computing resources may include instructing the at least a secondary system to, as portions of the computing resources become free, to reserve the free computing resources so that the free computing resources are not allocated toward provisioning of other computer-implemented services at the future point in time.

The service systems may cooperatively provide a plurality of computer-implemented services, and the load balancer may distribute load for the plurality of the computer-implemented services to the service systems using load balancing policies.

The occurrence of the future event may be likely to result in a change in a ratio of demand for the computer-implemented services to computing resources of the service systems allocated for providing the computer-implemented services.

The new load balancing policy, when enforced, may reduce a load on the primary system, and may increase a load on the at least a secondary system.

A non-transitory media may include instructions that when executed by a processor cause the computer-implemented method to be performed.

The data processing system may include the non-transitory media and a processor, and may perform the computer-implemented method when the computer instructions are executed by the processor.

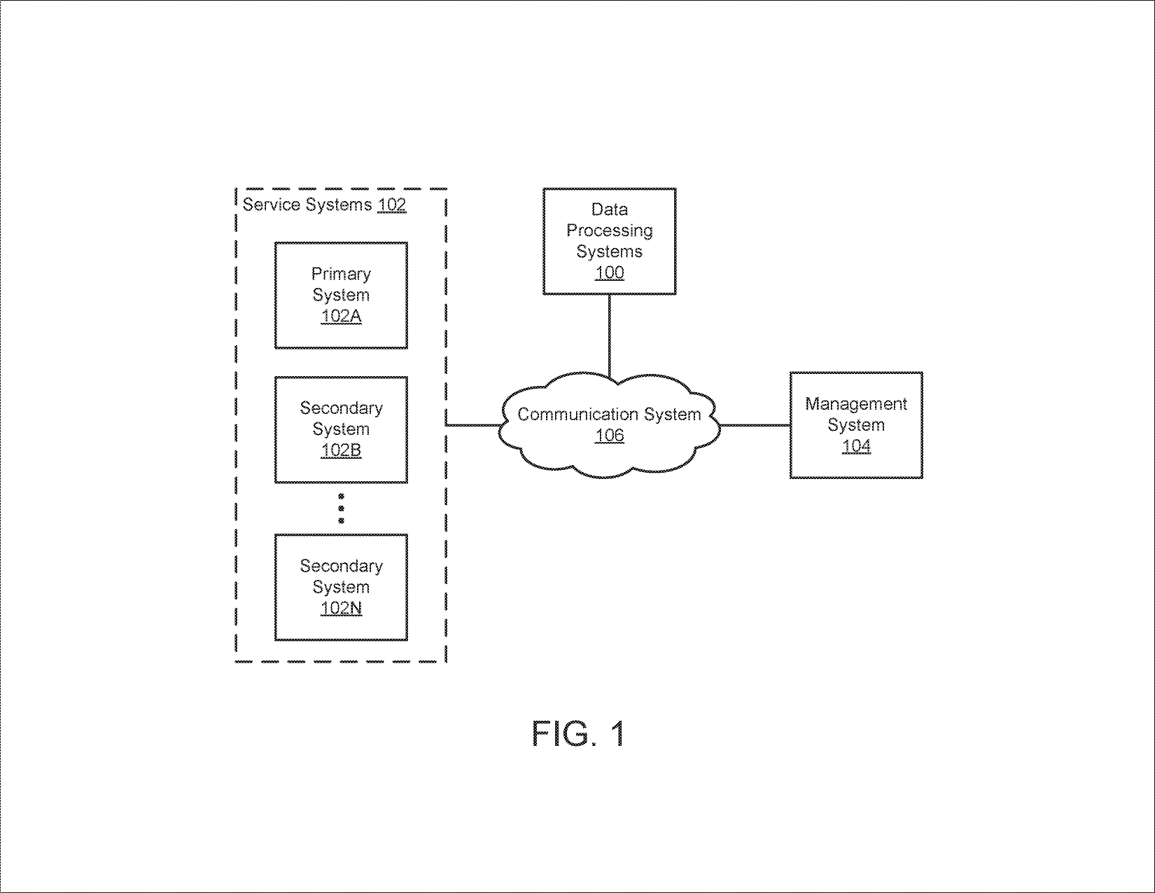

Turning to FIG. 1, a block diagram illustrating a distributed system in accordance with an embodiment is shown. The system shown in FIG. 1 may provide computer-implemented services. The computer-implemented services may include any type and quantity of computer-implemented services. For example, the computer-implemented services may include communication services, data storage services, database services, data generation services, and/or any other type of service that may be implemented with a computing device. Any of the services provided by the system may include artificial intelligence based services. Other types of services may be provided by the system shown in FIG. 1 without departing from embodiments disclosed herein.

To provide the (computer-implemented) services, the system may include any number of data processing systems (e.g., service systems). The data processing systems may include any quantity of hardware resources (e.g., software components and/or hardware components). The hardware resources may include, for example, processors, memory modules, storage devices, communications devices, power components, software applications, device drivers, and/or any other type of component whose respective operation may facilitate various functionalities of the data processing systems.

For example, the provide the services, a data processing system may obtain and fulfill requests for service from downstream consumers of the services. To service the requests, the hardware resources may perform a magnitude of computational work in a period of time, placing a load on the data processing system. Depending on types and/or quantities of the hardware resources, the data processing system may be able to service a maximum number of requests in a period of time without becoming overloaded.

Over time, a demand for services may change and/or performance of the hardware resources may change, which may cause the data processing system to experience different loads. For example, if a hardware component fails and/or a demand for a particular service increases, then the data processing system may become overloaded and be unable to service incoming requests as expected. Or, for example, if the demand for the service increases, then the data processing system may become overloaded. This may result in a reduction in quality of the provided services.

Therefore, to manage changes in loads (e.g., workloads) over time across multiple service systems, a load balancer may use a load balancing method to distribute the load among the service systems to avoid overloading any of the service systems. However, static load balancing methods may not result in efficient use of computing resources over time as the static load balancing methods may not take changes in conditions (e.g., operating conditions, environmental conditions) into account. To manage load balancing in view of these changes, dynamic load balancing may be implemented.

Dynamic load balancing may be implemented based on load balancing policies for the service systems. For example, a load balancer may enforce different load balancing policies based on changes in types and/or quantities of incoming service requests over time and/or changes in availability (e.g., performance) of computing resources of the service systems over time. The load balancing policies may be enforced to optimize performance, improve response times, avoid bottlenecks, maintain stability of the service systems, reduce failures, and/or to achieve other operational goals over time.

Consider an example where a primary system of the service systems is tasked with servicing requests for a website used to sell a product to consumers. At some point in time, an event may occur that causes the primary system to be unable to service incoming requests as expected due to being overloaded. For example, the primary system may experience a hardware failure and/or a sudden increase in demand for the product (e.g., an increase in requests to view the product catalog). This may cause the primary system to reject the incoming requests, throw errors, and/or otherwise reduce a quality of the website services, which may result in an inability for the consumers to purchase the product and/or a decrease in sales of the product.

To avoid overloading the primary system with requests (e.g., to continue to provide reliable website services), operation of the primary system (e.g., performance and/or availability of computing resources thereof) may be monitored, and different load balancing policies may be enforced based on an analysis of the operation. For example, a portion of traffic (e.g., a portion of the requests) directed to the primary system may be redirected to a secondary system (or secondary systems) as specified by the load balancing policies in order to reduce the load on the primary system.

However, in order to prepare the secondary system(s) to take on the redirected traffic, computing resources of the secondary system(s) may need to be allocated for contribution toward the website services. Allocating the computing resources may require time to plan and schedule the computing resources (e.g., to identify a quantity and/or type of computing resources required), and/or time for the identified computing resources to become free. For example, a workload queue for the identified computing resources may need to be cleared, and the computing resources may need to be prepared (e.g., configured) to provide the website service as desired. Therefore, depending on the workload queue and/or other scheduling factors, the computing resources may not be available for contribution toward the website services for a period of time.

A new load balancing policy for the service systems may be defined once the computing resources are successfully allocated (e.g., reserved for contribution toward the computer-implemented service). For example, the new load balancing policy may specify redirection of the portion of the traffic to the newly allocated computing resources. Therefore, until the computing resources are allocated, the new load balancing policy may not be defined and/or enforced, and the primary system may remain overloaded, causing a reduction in quality of the website services for at least the period of time.

In general, embodiments disclosed herein may provide methods, systems, and/or devices for managing dynamic load balancing for service systems in a proactive manner. To do so, changes in availability of computing resources of the service systems and/or demand for services provided by the service systems may be monitored in order to predict occurrences of future events that are likely to reduce a quality of the services at a future point in time. Prior to the future point in time, computing resources may be allocated for contribution toward the services, and new load balancing policies may be defined to manage outcomes of the predicted occurrences of the future events.

Returning to the example above, a management system may monitor operation of the primary system to predict an occurrence of a future event such as a hardware failure and/or a sudden increase in demand for website services. The future event may be predicted to occur at a future point in time. Based on the prediction, the management system may initiate allocation of computing resources of the secondary system(s) starting at a point in time likely to result in the computing resources being successfully allocated prior to the future point in time. A new load balancing policy that specifies rerouting of at least a portion of requests for the primary system to the allocated resources of the secondary system(s) may be obtained and staged with a load balancer for the service systems prior to the future point in time.

The management system may continue to monitor operation of the primary system in order to make a determination that the occurrence of the future event is imminent. Upon doing so, as the computing resources of the secondary system(s) were allocated prior to the future point in time, the load balancer may be notified to enforce the new load balancing policy. By doing so, the load balancer may enforce the new load balancing policy without delay, and the website services may be more likely to be provided despite occurrence of the future event.

To provide the above-mentioned functionality, the distributed system of FIG. 1 may include data processing systems 100, service systems 102, management system 104, and communication system 106. The distributed system, any components thereof, and/or any other types of devices or components not shown in FIG. 1 may perform all, or a portion of the computer-implemented services independently and/or cooperatively. Each of these components is discussed below.

Data processing systems 100 may include any number of data processing systems. Data processing systems 100 may host (and/or otherwise operate) any number of systems that provide, at least in part, computer-implemented services. For example, data processing systems 100 may obtain a first portion of services from any of service systems 102 and/or provide a second portion of the services to other entities (e.g., a user of data processing systems 100).

To obtain the services from service systems 102, data processing system may, for example, provide service requests to service systems 102. For example, data processing systems 100 may be operated by different users to browse a website, and each of data processing systems 100 may request different types of website services from service systems 102 over time. Volumes and/or types of requests generated by data processing systems 100 may vary over time, causing variations in load on service systems 102 over time.

Service systems 102 may include any number of service systems (e.g., data processing systems configured to provide specific computer-implemented services). Service systems 102 may provide a plurality of computer-implemented services independently and/or cooperatively (e.g., in some combination). For example, service systems 102 may include a primary system 102A tasked with servicing requests from downstream consumers (e.g. data processing systems 100, users thereof, and/or other data processing systems), and any number of secondary systems (e.g., 102B-102N) tasked with servicing rerouted requests and/or providing other types of services.

Service systems 102 may be managed by an orchestration system. Service systems 102 may receive workloads for execution (e.g., requests for servicing), and the orchestration system may provide a mechanism that deploys, maintains, and/or scales applications hosted by service systems 102 based on requirements of different types of workloads. The orchestration system may include a load balancer. The load balancer may distribute load (e.g., service requests) for the plurality of the computer-implemented services to service systems 102 based on load balancing policies for service systems 102. For example, the load balancing policies may specify how incoming requests should be assigned among service systems 102 for servicing.

To facilitate proactive management of load balancing for service systems 102, operation of service systems 102 may be monitored over time, and operation data obtained through monitoring may be analyzed to predict occurrences of future events that may be likely to reduce a quality of the services provided by service systems 102. For example, service systems 102 may include functionality for reporting the operation data to management system 104 for analysis.

Management system 104 may include any number of data processing systems and may provide a variety of services for service systems 102. For example, management system 104 may provide monitoring services, data analysis services, policy management services, and/or management services. Management system 104 may provide the services, at least in part, to facilitate dynamic load balancing for service systems 102.

For example, management system 104 may (i) monitor operation of service systems 102 to obtain (e.g., collect) operation data for service systems 102, (ii) analyze the operation data to predict occurrences of future events likely to decrease a quality of services provided by service systems 102, (iii) initiate allocation of computing resources based on the predicted occurrences of the future events, (iv) obtain (e.g., generate) new load balancing policies based, in part, on the allocated computing resources, (v) stage the new load balancing policies with the load balancer of service systems 102, (vi) determine whether predicted occurrences of the future events are imminent (e.g., within a threshold), and/or (vii) initiate enforcement of the new load balancing policies to mitigate impacts of the predicted occurrences of the future events.

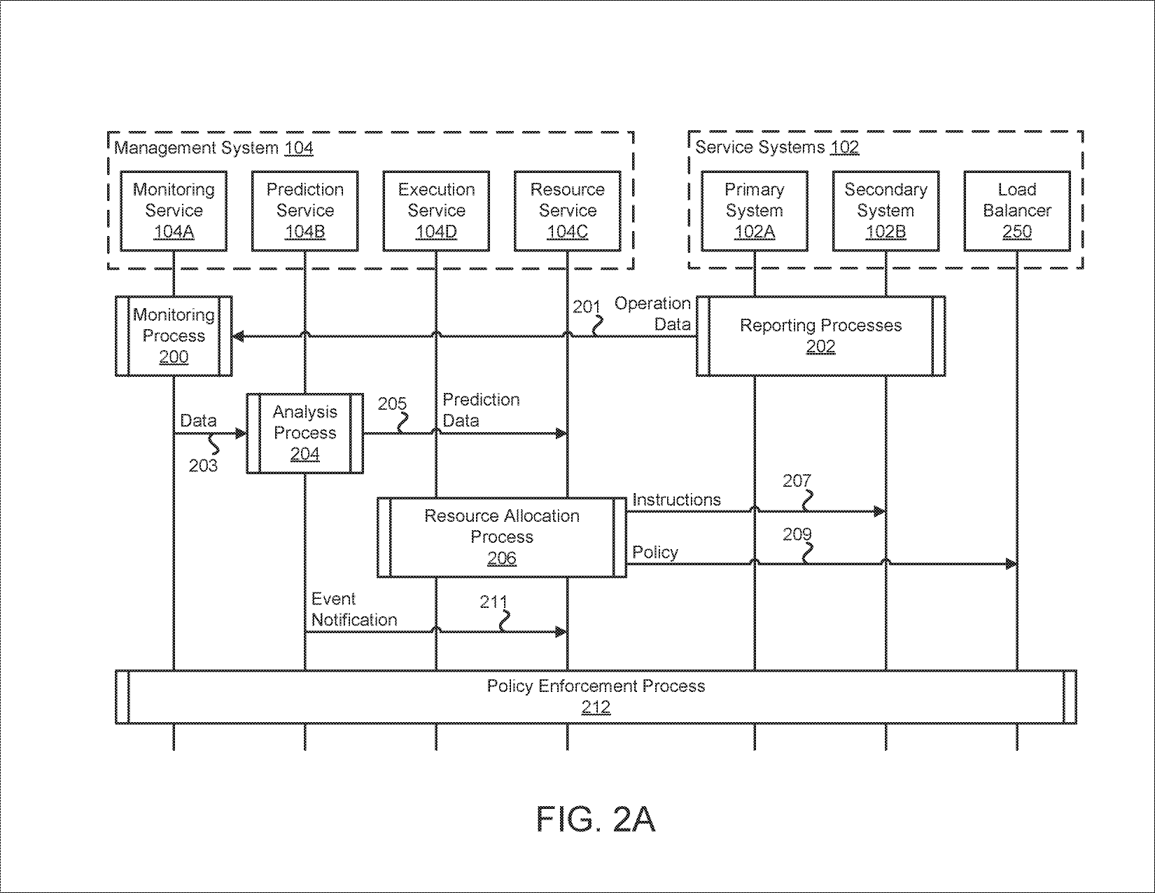

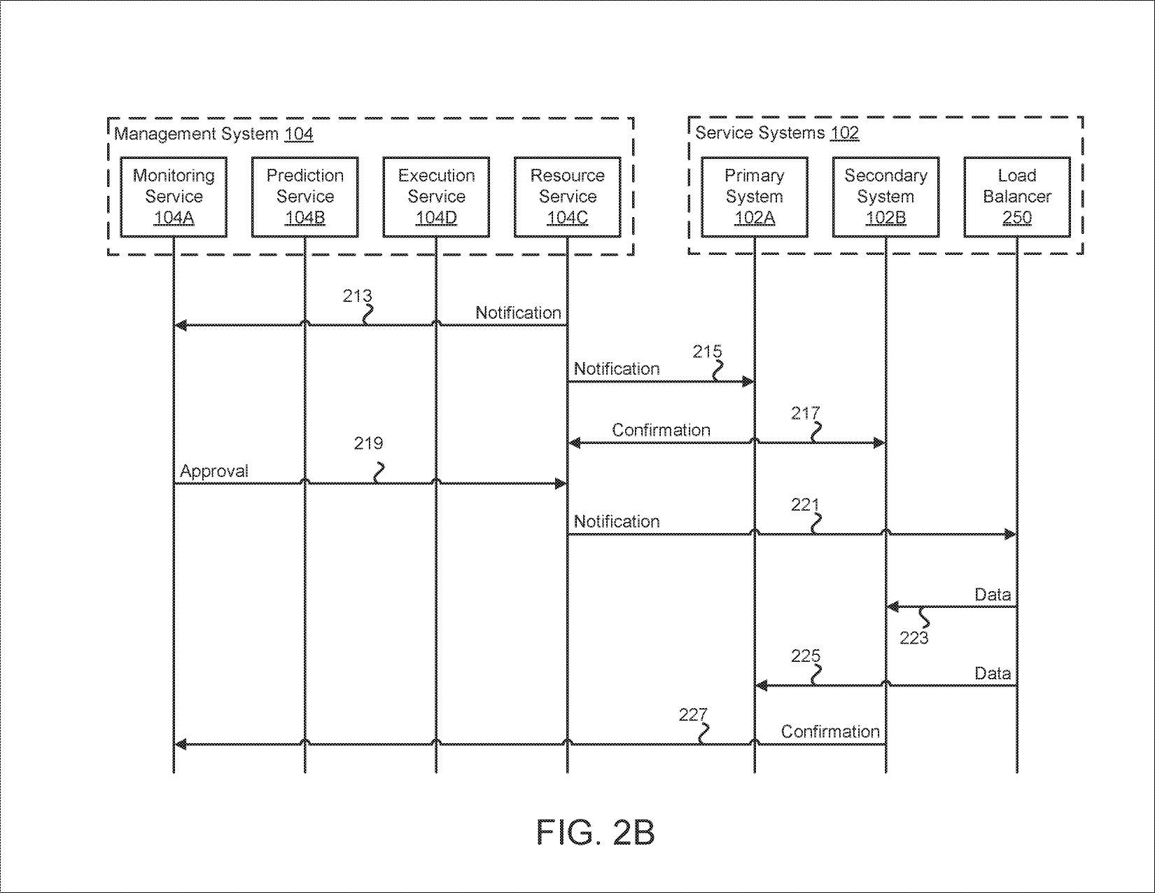

The predicted occurrences of the future events may include a temporal component, the temporal component indicating future points in time that the future events are likely to occur. Management system 104 may perform actions at points in time based on the future points in time to reduce and/or prevent delays in managing the impacts of the predicted occurrences of the future events. By doing so, dynamic load balancing for service systems 102 may be more likely to enforced in timely manner, reducing a likelihood of reductions in quality of the computer-implemented services. Refer to FIGS. 2A-2B for more details regarding dynamic load balancing.

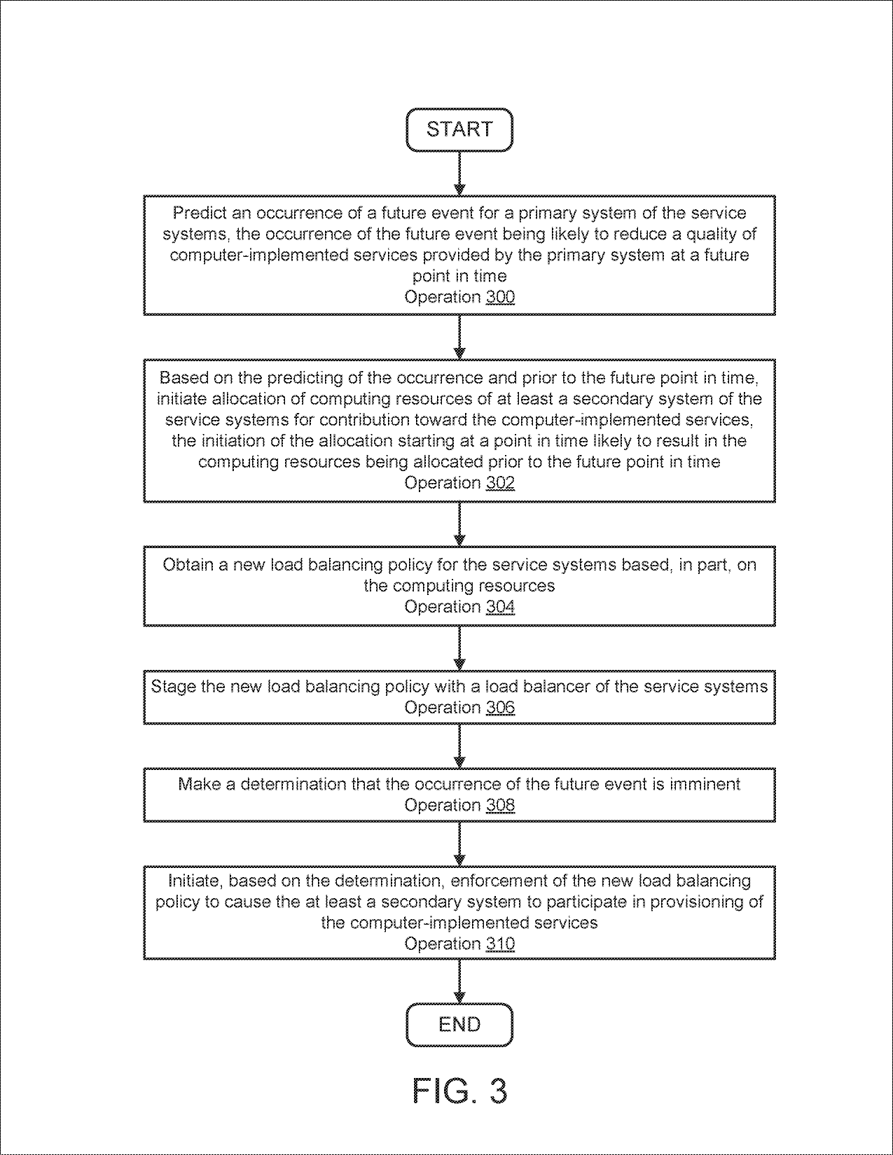

When providing their functionality, any of data processing systems 100, service systems 102, management system 104, and/or components thereof may perform all, or a portion of the actions and methods illustrated in FIGS. 2A-3.

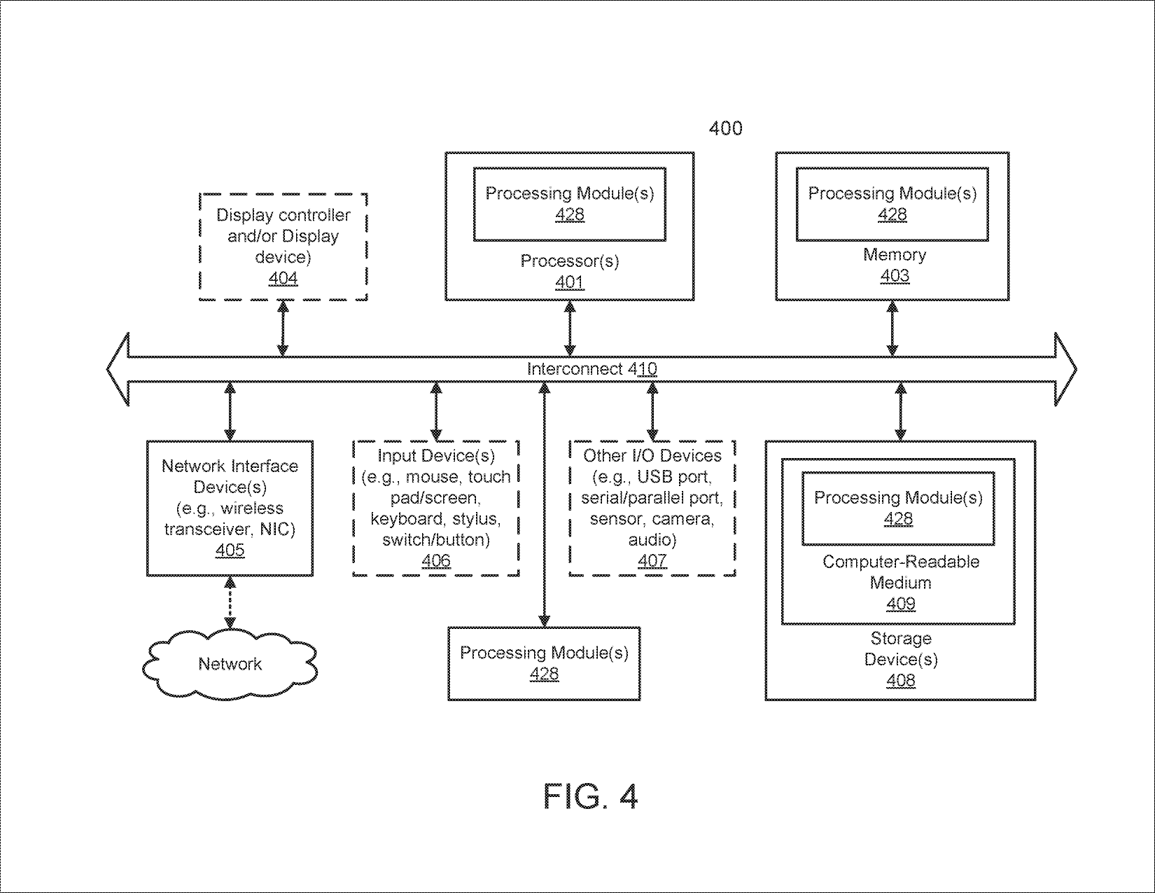

Any of data processing systems 100, service systems 102, and management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, interaction diagrams in accordance with an embodiment are shown in FIGS. 2A-2B. These interaction diagrams may illustrate how data may be obtained and used within the system of FIG. 1.

In the interaction diagrams, processes performed by and interactions between components of a system in accordance with an embodiment are shown. In the diagrams, components of the system are illustrated using a first set of shapes (e.g., 104A, 104B, etc.), located towards the top of each figure. Lines descend from these shapes. Processes performed by the components of the system are illustrated using a second set of shapes (e.g., 200, 202, etc.) superimposed over these lines. Interactions (e.g., communication, data transmissions, etc.) between the components of the system are illustrated using a third set of shapes (e.g., 201, 203, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 201 may occur prior to the interaction labeled as 203. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during management of dynamic load balancing for service systems. In the example shown in FIG. 2A, service systems 102 may include primary system 102A and secondary system 102B.

Primary system 102A may provide computer-implemented services to downstream consumers (e.g., data processing systems 100). To do so, primary system 102A may perform workloads based on requests for the computer-implemented services. Secondary system 102B may perform workloads for a portion of the computer-implemented services and/or other computer-implemented services. When performing the workloads, portions of computing resources (e.g., hardware resources) of service systems 102 may be in use (e.g., not free).

To manage load balancing for service systems 102, load balancer 250 may use an existing load balancing policy to distribute workloads (e.g., assign the requests) to service systems 102. For example, the existing load balancing policy may distribute all requests to primary system 102A for servicing. In other words, a portion of computing resources of primary system 102A may be used to provide the computer-implemented services.

To manage service systems 102, management system 104 may include various service components. For example, the service components may include service modules such as monitoring service 104A, prediction service 104B, resource service 104C, execution service 104D, and/or other service modules (not shown). Services provided by each of the service components of management system 104 are discussed below.

Management system 104 may include monitoring service 104A. For example, monitoring service 104A may be tasked with collecting various metrics (e.g., performance metrics) for applications hosted by service systems 102 and/or from other devices (e.g., third-party management applications monitoring health and/or different components of service systems 102).

To monitor operation of service systems 102, monitoring service 104A may perform monitoring process 200. During monitoring process 200, management system 104 may obtain operation data from primary system 102A, secondary system 102B, and/or other systems of service systems 102 (not shown). The operation data may include (i) information regarding demand for the computer-implemented services over time, (ii) information regarding availability of computing resources of service systems 102 for provisioning of the computer-implemented services, and/or (iii) other information usable to assess performance of service systems 102 while providing the computer-implemented services.

Monitoring service 104A may obtain the operation data based on monitoring parameters. The monitoring parameters may indicate which of service systems 102 are monitored, types and/or quantities of operation data to collect, how often the operation data is to be collected, etc. For example, the operation data may include performance metrics for hardware resources of service systems 102, magnitudes of network traffic, and/or other data usable to measure a system load on any of service systems 102 (e.g., a number of incoming, serviced, and/or rejected requests per period of time).

Monitoring process 200 may be an ongoing process, during which operation data is obtained from service systems 102 periodically (e.g., based on a schedule and/or other factors). In a first example, management system 104 may obtain the operation data via an application hosted by management system 104 and running on service systems 102. In a second example, monitoring process 200 may be performed in cooperation with reporting processes 202. For example, reporting processes 202 may be performed periodically by any of service systems 102. During reporting processes 202, any of service systems 102 may report their respective operation data to management system 104.

At interaction 201, the operation data may be provided to monitoring service 104A by service systems 102 (e.g., primary system 102A and/or secondary system 102B). For example, the operation data may be generated and provided to monitoring service 104A via (i) transmission via a message, (ii) storing in a storage with subsequent retrieval by monitoring service 104A, (iii) a publish-subscribe system where monitoring service 104A subscribes to updates from service systems 102 thereby causing a copy of the operation data to be propagated to monitoring service 104A, and/or (iv) other processes. Note that all interactions between components shown in FIGS. 2A-2B may be performed using methods similar to those described with respect to interaction 201.

Monitoring service 104A may use the operation data to generate performance metrics, identify operational issues, and/or to provide other types of services regarding operation of service systems 102. For example, monitoring service 104A may use the operation data to obtain information regarding workload performance and/or other types of activity by hardware resources of service systems 102 to identify immediate operational issues affecting service systems 102. To do so, monitoring service 104A may obtain a statistical characterization of the operation data (e.g., average values, median values, ratios) and compare the statistical characterization to predefined thresholds of operation. If monitoring service 104A identifies an immediate operational issue (e.g., when the operation data is not within the predefined thresholds), then monitoring service 104A may perform actions to notify other service components of management system 104, and/or perform other types of actions (not shown).

To proactively manage load balancing for service systems 102, the operation data may be used, in part, to predict an occurrence of a future event for service systems 102. To do so, management system 104 may include prediction service 104B. For example, prediction service 104B may use a machine learning algorithm such as logistic regression to predict workloads at future points in time based on trends in operation (e.g., performance) of service systems 102. At interaction 203, data (e.g., the operation data, statistical characterizations thereof, and/or other information) may be provided to prediction service 104B by monitoring service 104A.

Prediction service 104B may perform analysis process 204 to predict an occurrence of a future event for primary system 102A likely to reduce a quality of the computer-implemented services provided by primary system 102A at a future point in time. During analysis process 204, the operation data may be analyzed to obtain a prediction regarding changes in demand for the computer-implemented services over time, changes in availability of computing resources of service systems 102 for provisioning of the computer-implemented services over time, and/or other information. For example, the operation data may be analyzed using an inference model trained to predict occurrences of future events for service systems 102 based on the operational data. The inference model may be trained, for example, using historical operation data (e.g., operation data collected over time may be stored in a data repository by monitoring service 104A), historical occurrences of events for service systems 102, and/or other information.

The occurrence of the future event may be likely to result in a change in a ratio of demand for the computer-implemented services to computing resources of the service systems allocated for providing the computer-implemented services. For example, during analysis process 204, the inference model may be used to obtain a prediction of an increase in demand for the computer-implemented services provided by primary system 102A over time, and/or a decrease in availability of computing resources of primary system 102A for provisioning of the computer-implemented services over time. This change in the ratio of demand to resource availability may cause primary system 102A to experience a system load beyond a maximum load for primary system 102A at the future point in time.

Returning to the website services example, the occurrence of the future event may include a predicted increase in sales of the product sold via the website at the future point in time, and/or a failure of hardware resources of primary system 102A at the future point in time. In other words, at the future point in time, primary system 102A may begin to obtain more requests per period of time than it is able to service, and therefore may become overloaded (e.g., begin rejecting requests and/or be otherwise unable to provide the computer-implemented services as expected).

During analysis process 204, prediction service 104B may obtain prediction data. The prediction data may include information regarding the predicted occurrence of the future event, such as (i) an identifier for the future event, (ii) predicted system loads (e.g., workloads) for service systems 102 over time (e.g., predicted workload types, measurements of system load over time), (iii) a predicted time of occurrence of the future event (e.g., the future point in time), and/or (iv) other information.

The prediction data may be used to proactively manage an impact of the occurrence of the future event. To do so, management system 104 may include resource service 104C. Resource service 104C may manage resource allocation for service systems 102 and may include logic for determining actions for execution to mitigate the impact of the occurrence of the future event. For example, resource service 104C may generate instructions for assigning and/or reserving portions of computing resources of service systems 102 for provisioning of different computer-implemented services.

Monitoring service 104A and prediction service 104B may continue to obtain and analyze operation data from service systems 102 over time. For example, prediction service 104B may use real-time operation data obtained by monitoring service 104A to predict operation of primary system 102A over time in order to monitor a level of accuracy of the prediction (e.g., the prediction data) and/or to refine the prediction.

At interaction 205, the prediction data may be provided to resource service 104C. Resource service 104C may use the prediction data to initiate allocation of computing resources for contribution toward the computer-implemented services. To do so, resource service 104C may perform resource allocation process 206. During resource allocation process 206, resource service 104C may identify a type and/or minimum quantity of computing resources necessary to reduce the predicted system load for primary system 102A at the future point in time (e.g., and/or for a period of time thereafter) to an acceptable level. For example, the acceptable level of system load may be specified by policies for each service systems 102.

During resource allocation process 206, resource service 104C may obtain (e.g., generate) resource data. The resource data may include, for example, identifiers for the computing resources for contribution toward the computer-implemented services, instructions for initiating allocation of the computing resources, and/or other information (e.g., information regarding the predicted occurrence of the future event such as the future point in time). For example, the resource data may be used to identify a portion of computing resources of secondary system 102B.

To automatically initiate allocation of the computing resources, management system 104 may include execution service 104D. Execution service 104D may include an infrastructure as code (IaC) module. For example, execution service 104D may execute instructions from the resource data and/or use the resource data to generate instructions for allocating the computing resources. The instructions may include (i) instructions for clearing a workload queue for secondary system 102B to free the computing resources prior to the future point in time, (ii) instructions for reserving the computing resources so that the free computing resources are not allocated towards provisioning of other computer-implemented services at the future point in time, and/or (iii) other instructions.

At interaction 207, the instructions may be provided to secondary system 102B by execution service 104D. Secondary system 102B may execute the instructions to allocate the computing resources.

Resource service 104C may start to initiate allocation of the computing resources at a point in time likely to result in the computing resources being allocated (e.g., freed and reserved) prior to the future point in time. For example, secondary system 102B may obtain the resource data at a point in time sufficient for secondary system 102B to complete clearing of workload queues and to otherwise complete allocation of (e.g., configuration of, preparation of) the computing resources prior to the future point in time. By doing so, the computing resources of secondary system 102B may be pre-emptively allocated in preparation for the occurrence of the future event.

During resource allocation process 206, resource service 104C may use the resource data (e.g., identifiers for the computing resources) to obtain a new load balancing policy for service systems 102. The new load balancing policy may take into account the computing resources to ensure that the computing resources are used in the provisioning of the computer-implemented services once the new load balancing policy is enforced. For example, the new load balancing policy may specify that at least a portion of the requests routed to primary system 102A be rerouted to (the allocated computing resources of) secondary system 102B.

The new load balancing policy may include (i) instructions for updating computing resource configurations of service systems 102 (e.g., instructions for scaling computing resources of service systems 102), (ii) instructions for rebalancing workloads across systems (e.g., rerouting instructions), (iii) pieces of software (e.g., application updates), and/or (iv) other information relating to load balancing and/or provisioning of the computer-implemented services.

Execution service 104D may stage the new load balancing policy with load balancer 250. At interaction 209, the policy (e.g., the new load balancing policy) may be provided to load balancer 250 for staging by execution service 104D. For example, load balancer 250 may store the new load balancing policy (e.g., in local memory) for future timely use. Load balancer 250 may not enforce the new load balancing policy until the future point in time and/or until instructions to enforce the new load balancing policy are received from management system 104.

At interaction 211, an event notification may be provided to resource service 104C by prediction service 104B. For example, prediction service 104B may make a determination that the occurrence of the future event is imminent while monitoring operation of service systems 102 leading up to the future point in time (e.g., as more operation data is obtained from service systems 102). Prediction service 104B may compare the current operation of primary system 102A to the predicted operation of primary system 102A over time to identify a level of accuracy of the prediction. If the level of accuracy meets criteria (e.g., is within a predetermined threshold), then the occurrence of the future event may be imminent when it is likely to occur within a threshold duration of time prior to the future point in time.

When the occurrence of the future event is determined to be imminent, policy enforcement process 212 may be initiated. Policy enforcement process 212 may be initiated by resource service 104C upon obtaining the event notification and/or may be initiated by any other service component of management system 104 for other reasons. The existing load balancing policy used by load balancer 250 may not take into account the computing resources of secondary system 102B when assigning requests for the computer-implemented services for servicing. During policy enforcement process 212, the new load balancing policy may be enforced to cause secondary system 102B to participate in provisioning of the computer-implemented service, thereby reducing a load on primary system 102A and/or increasing a load on secondary system 102B. Refer to FIG. 2A for an detailed example of interactions that may occur during policy enforcement process 212.

Turning to FIG. 2B, a second interaction diagram in accordance with an embodiment is shown. The second interaction diagram may illustrate processes and interactions that may occur during enforcement of a new load balancing policy for service systems. The second interaction diagram may illustrate example of policy enforcement process 212 of FIG. 2A.

During the policy enforcement process, resource service 104C may obtain (e.g., generate) a notification for monitoring service 104A. The notification may indicate the imminent occurrence of the future event and/or may include information usable for monitoring service 104A to adjust monitoring parameters and/or operation thresholds so that monitoring processes performed by monitoring services 104A may be more likely to detect whether service systems 102 are operating in accordance with the new load balancing policy. At interaction 213, the notification may be provided to monitoring service 104A by resource service 104C.

Resource service 104C may obtain (e.g., generate) a notification for primary system 102A. The notification may indicate that primary system 102A should prepare for a potential change in load (e.g., requests) to prepare for enforcement of the new load balancing policy. At interaction 215, the notification may be provided to primary system 102A by resource service 104C. For example, upon obtaining the notification, primary system 102A may modify workload queues (e.g., reprioritize workloads within the queues, add or remove workloads from the queues) in accordance with the new load balancing policy.

To confirm that computing resources of secondary system 102B are in a state conducive to providing the computer-implemented services as desired, resource service 104C and secondary system 102B may exchange data. For example, at interaction 217, resource service 104C may request confirmation from secondary system 102B that the computing resources are allocated and/or ready to service incoming requests, and/or secondary system 102B may provide the confirmation to resource service 104C.

At interaction 219, monitoring service 104A may provide an approval to resource service 104C. For example, monitoring service 104A may continue to monitor operation of service systems 102 to detect whether any of service systems 102 implicated in the new load balancing policy are operating outside operational thresholds, and an approval for enforcement of the new load balancing policy may only be issued when the implicated systems are operating within the operational thresholds.

To prompt load balancer 250 to use the new load balancing policy when assigning requests for servicing by service systems 102, resource service 104C may obtain (e.g., generate) a notification for load balancer 250. At interaction 221, the notification may be provided to load balancer 250 by resource service 104C. The notification may indicate, for example, that load balancer 250 is to begin using the new load balancing policy at a specified period in time (e.g., immediately, after a duration of time).

Load balancer 250 may identify the new load policy (e.g., stored in local memory) based on the notification, and may begin to assign at least a portion of incoming requests for the computer-implemented services to secondary system 102B for servicing, thereby reducing a load on primary system 102A and increasing a load secondary system 102B.

At interaction 223, load balancer 250 may provide data (e.g., requests, a notification indicating secondary system 102B may experience an increase in load for at least a period of time) to secondary system 102B. At interaction 225, load balancer 250 may provide data (e.g., requests, a notification indicating primary system 102A may experience a decrease in load for at least a period of time) to primary system 102A.

At interaction 227, a confirmation obtained (e.g., generated) by secondary system 102B may be provided to monitoring service 104A. The confirmation may be obtained by monitoring service 104A as part of a monitoring process (and/or a reporting process) where operation data for secondary system 102B indicates secondary system 102B is operating within operational thresholds associated with the new load balancing policy. For example, the confirmation (e.g., the operation data) may indicate that secondary system 102B is servicing requests for the computer-implemented services as expected. Similarly, operation data for primary system 102A may be obtained by monitoring service 104A as confirmation that primary system 102A is servicing requests for the computer-implemented services as expected (not shown).

While service systems 102 are shown to include primary system 102A and secondary system 102B in FIGS. 2A-2B, it may be appreciated that service systems 102 may include any number of primary systems and/or secondary systems without departing from embodiments disclosed herein. Similarly, management system 104 may include any number of service components that may include any of monitoring service 104A, prediction service 104B, resource service 104C, and/or execution service 104D without departing from embodiments disclosed herein.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, using processes and interactions shown in FIGS. 2A-2B, dynamic load balancing for service systems may be managed proactively by predicting occurrences of future events and preparing the service systems for load balancing changes prior to the occurrences. By doing so, new load balancing policies may be enforced timely and without delays that may otherwise occur without proactive measures.

Turning to FIG. 3, a flow diagram illustrating a method in accordance with an embodiment is shown. The flow diagram may illustrate various operations performed while managing service systems.

At operation 300, an occurrence of a future event for a primary system of the service systems may be predicted. The occurrence of the future event being likely to reduce a quality of computer-implemented services provided by the primary system at a future point in time.

The occurrence of the future event may be predicted by (i) monitoring operation of a portion of the service systems to obtain operation data for the portion of the service systems, (ii) analyzing the operation data and/or other data to identify a trend (e.g., in operation, in demand for computer-implemented services provided by the service systems), and/or (iii) obtaining a notification from another system indicating that the occurrence of the future event is predicted. For example, the occurrence of the future event may be predicted using methods described with respect to monitoring process 200, reporting process 202, and/or analysis process 204 of FIG. 2A and/or by other methods.

Predicting the occurrence may include using an inference model to obtain a prediction of at least one selected from a group consisting of (i) changes in demand for the computer-implemented services over time, and/or (ii) changes in availability of computing resources of the service systems for provisioning of the computer-implemented services over time.

The inference model may be used to obtain the prediction by (i) training the inference model (e.g., using historical information regarding operation of the service systems and/or other systems, historical information regarding occurrences of events, and/or other information) using a machine-learning technique, and/or (ii) providing the (trained) inference model with ingest data such as operation data for the service systems. For example, the prediction may include a temporal component indicating that the occurrence of the future event is likely to occur at the future point in time and/or that the computer-implemented services are likely to be of reduced quality at the future point in time.

At operation 302, based on the predicting of the occurrence and prior to the future point in time, allocation of computing resources of at least a secondary system of the service systems for contribution toward the computer-implemented services may be initiated. The initiation of the allocation may start at a point in time likely to result in the computing resources being allocated prior to the future point in time.

The allocation of the computing resources may be initiated by performing a resource allocation process similar to resource allocation process 206 of FIG. 2A, and/or by other methods. For example, the allocation of the computing resources may be initiated by (i) identifying a quantity and/or type of computing resources required to contribute toward the computer-implemented services at the future point in time, (ii) identifying the computing resources based on a resource schedule for the service systems (e.g., the computing resources being of the at least a secondary system), (iii) obtaining (e.g., generating) instructions for freeing and/or reserving the identified computing resources, and/or (iv) transmitting the instructions (e.g., to the at least a secondary system).

Initiating allocation of the computing resources may include instructing the at least a secondary system to, as portions of the computing resources become free, to reserve the free computing resources so that the free computing resources are not allocated toward provisioning of other computer-implemented services at the future point in time. The at least a secondary system may be instructed to reserve the free computing resources by (i) obtaining (e.g., generating) instructions for the at least a secondary system to modify workload queues for the at least a secondary system so that the computing resources are freed prior to the future point in time, and/or (ii) providing the instructions for execution by the at least a secondary system.

At operation 304, a new load balancing policy for the service systems may be obtained based, in part, on the computing resources. The new load balancing policy may be obtained by (i) reading the new load balancing policy (e.g., from storage), (ii) receiving the new load balancing policy (e.g., from another device), and/or (iii) generating the new load balancing policy. For example, the new load balancing policy may be generated by modifying the existing load balancing policy so that the new load balancing policy specifies that a portion of requests routed to the primary system are to be rerouted to the at least a secondary system.

At operation 306, the new load balancing policy may be staged with a load balancer of the service systems. The new load balancing policy may be staged with the load balancer using methods described with respect to interaction 209 of FIG. 2A and/or by other methods. For example, the new load balancing policy may be staged with the load balancer by (i) obtaining a data package including the new load balancing policy and instructions for storing the new load balancing policy (e.g., in local memory), and/or (ii) providing the data package to the load balancer.

At operation 308, a determination may be made that the occurrence of the future event is imminent. The determination may be made by (i) monitoring operation of at least a portion of the service systems leading up to the future point in time, (ii) comparing the operation to the prediction to identify a level of accuracy of the prediction, and (iii) in an instance of the comparing where the level of accuracy meets criteria, identifying that a current time is within a threshold duration of time to the future point in time.

Operation of the at least a portion of the service systems may be monitored by performing a monitoring process similar to monitoring processes 202 of FIG. 2A to obtain current operation data indicating current operation of the at least a portion of the service systems and/or by other methods.

The operation may be compared to the prediction by (i) comparing the current operation data with the operation data used to obtain the prediction, and/or (ii) generating a new prediction using the current operation data and comparing the new prediction to the prediction. The comparing may include (i) obtaining statistical characterizations of the operation data, the new operation data, the prediction, and/or the new prediction, and (ii) evaluating a mathematical function of the statistical characterization(s) to obtain the level of accuracy.

If the level of accuracy meets the criteria (e.g., the criteria may include threshold values that indicate similarity between the statistical characterizations), then the future event may be likely to occur at the future point in time.

The current time may be identified to be within the threshold duration of time to the future point in time by (i) obtaining the current time, (ii) obtaining a delta (e.g., evaluating a mathematical function of the current time and the future point in time), and/or (iii) comparing the delta to the threshold duration of time. For example, if the delta is less than the threshold duration of time, then the future event may be determined to be imminent.

At operation 310, enforcement of the new load balancing policy may be initiated to cause the at least a secondary system to participate in provisioning of the computer-implemented service. Enforcement of the new load balancing policy may be initiated by performing a policy enforcement process similar to policy enforcement process 212 of FIG. 2A, by performing any of the interactions described with respect to FIG. 2B, and/or by other methods. For example, enforcement of the new load balancing policy may be initiated by (i) performing checks (e.g., obtaining confirmations, approvals) to determine whether the service systems are prepared for enforcement of the new load balancing policy, (ii) providing instructions to the service systems to prepare for enforcement of the new load balancing policy, and/or (iii) instructing (e.g., providing instructions to) the load balancer to begin using the new load balancing policy.

The method may end following operation 310.

Thus, as illustrated above, embodiments disclosed herein may provide systems and methods for proactively managing dynamic load balancing for service systems that provide computer-implemented services. By predicting and preparing for occurrences of future events that may be likely to reduce the quality of the computer-implemented services at future points in time, delays in enforcing new load balancing policies (e.g., caused by resource scheduling) may be prevented. As a result, the service systems may be more likely to continue to provide the computer-implemented services as expected despite the occurrences of the future events.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system’s registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing service systems, the method comprising:
predicting an occurrence of a future event for a primary system of the service systems, the occurrence of the future event being likely to reduce a quality of computer-implemented services provided by the primary system at a future point in time; and
based on the predicting of the occurrence and prior to the future point in time:
initiating allocation of computing resources of at least a secondary system of the service systems for contribution toward the computer-implemented services, the initiation of the allocation starting at a point in time likely to result in the computing resources being allocated prior to the future point in time,
obtaining a new load balancing policy for the service systems based, in part, on the computing resources,
staging the new load balancing policy with a load balancer of the service systems,
making a determination that the occurrence of the future event is imminent, and
initiating, based on the determination, enforcement of the new load balancing policy to cause the at least a secondary system to participate in provisioning of the computer-implemented services.

2. The method of claim 1, wherein prior to initiating enforcement of the new load balancing policy, an existing load balancing policy is used by the load balancer to assign requests for the computer-implemented services for servicing by the service systems, and the existing load balancing policy does not take into account the computing resources.

3. The method of claim 2, wherein the new load balancing policy takes into account the computing resources to ensure that the computing resources are used in the provisioning of the computer-implemented services once the new load balancing policy is enforced.

4. The method of claim 1, wherein predicting the occurrence comprises:
using an inference model to obtain a prediction of at least one selected from a group consisting of:
changes in demand for the computer-implemented services over time, and
changes in availability of computing resources of the service systems for provisioning of the computer-implemented services over time.

5. The method of claim 4, wherein making the determination comprises:
monitoring operation of at least a portion of the service systems leading up to the future point in time;
comparing the operation to the prediction to identify a level of accuracy of the prediction; and
in an instance of the comparing where the level of accuracy meets criteria:
identifying that a current time is within a threshold duration of time to the future point in time.

6. The method of claim 1, wherein initiating allocation of the computing resources comprises:
instructing the at least a secondary system to, as portions of the computing resources become free, to reserve the free computing resources so that the free computing resources are not allocated toward provisioning of other computer-implemented services at the future point in time.

7. The method of claim 1, wherein the service systems cooperatively provide a plurality of computer-implemented services, and the load balancer distributes load for the plurality of the computer-implemented services to the service systems using load balancing policies.

8. The method of claim 7, wherein the occurrence of the future event is likely to result in a change in a ratio of demand for the computer-implemented services to computing resources of the service systems allocated for providing the computer-implemented services.

9. The method of claim 7, wherein the new load balancing policy, when enforced, reduces a load on the primary system, and increases a load on the at least a secondary system.

10. A non-transitory machine-readable medium having instructions stored therein, which when executed by a processor, cause the processor to perform operations for managing service systems, the operations comprising:
predicting an occurrence of a future event for a primary system of the service systems, the occurrence of the future event being likely to reduce a quality of computer-implemented services provided by the primary system at a future point in time; and
based on the predicting of the occurrence and prior to the future point in time:
initiating allocation of computing resources of at least a secondary system of the service systems for contribution toward the computer-implemented services, the initiation of the allocation starting at a point in time likely to result in the computing resources being allocated prior to the future point in time,
obtaining a new load balancing policy for the service systems based, in part, on the computing resources,
staging the new load balancing policy with a load balancer of the service systems,
making a determination that the occurrence of the future event is imminent, and
initiating, based on the determination, enforcement of the new load balancing policy to cause the at least a secondary system to participate in provisioning of the computer-implemented services.

11. The non-transitory machine-readable medium of claim 10, wherein prior to initiating enforcement of the new load balancing policy, an existing load balancing policy is used by the load balancer to assign requests for the computer-implemented services for servicing by the service systems, and the existing load balancing policy does not take into account the computing resources.

12. The non-transitory machine-readable medium of claim 11, wherein the new load balancing policy takes into account the computing resources to ensure that the computing resources are used in the provisioning of the computer-implemented services once the new load balancing policy is enforced.

13. The non-transitory machine-readable medium of claim 10, wherein predicting the occurrence comprises:
using an inference model to obtain a prediction of at least one selected from a group consisting of:
changes in demand for the computer-implemented services over time, and
changes in availability of computing resources of the service systems for provisioning of the computer-implemented services over time.

14. The non-transitory machine-readable medium of claim 13, wherein making the determination comprises:
monitoring operation of at least a portion of the service systems leading up to the future point in time;
comparing the operation to the prediction to identify a level of accuracy of the prediction; and
in an instance of the comparing where the level of accuracy meets criteria:
identifying that a current time is within a threshold duration of time to the future point in time.

15. The non-transitory machine-readable medium of claim 10, wherein initiating allocation of the computing resources comprises:
instructing the at least a secondary system to, as portions of the computing resources become free, to reserve the free computing resources so that the free computing resources are not allocated toward provisioning of other computer-implemented services at the future point in time.

16. A data processing system, comprising:
a processor; and
a memory coupled to the processor to store instructions, which when executed by the processor, cause operations for managing service systems to be performed, the operations comprising:
predicting an occurrence of a future event for a primary system of the service systems, the occurrence of the future event being likely to reduce a quality of computer-implemented services provided by the primary system at a future point in time, and
based on the predicting of the occurrence and prior to the future point in time:
initiating allocation of computing resources of at least a secondary system of the service systems for contribution toward the computer-implemented services, the initiation of the allocation starting at a point in time likely to result in the computing resources being allocated prior to the future point in time;
obtaining a new load balancing policy for the service systems based, in part, on the computing resources;
staging the new load balancing policy with a load balancer of the service systems;
making a determination that the occurrence of the future event is imminent; and
initiating, based on the determination, enforcement of the new load balancing policy to cause the at least a secondary system to participate in provisioning of the computer-implemented services.

17. The data processing system of claim 16, wherein prior to initiating enforcement of the new load balancing policy, an existing load balancing policy is used by the load balancer to assign requests for the computer-implemented services for servicing by the service systems, and the existing load balancing policy does not take into account the computing resources.

18. The data processing system of claim 17, wherein the new load balancing policy takes into account the computing resources to ensure that the computing resources are used in the provisioning of the computer-implemented services once the new load balancing policy is enforced.

19. The data processing system of claim 16, wherein predicting the occurrence comprises:
using an inference model to obtain a prediction of at least one selected from a group consisting of:
changes in demand for the computer-implemented services over time, and
changes in availability of computing resources of the service systems for provisioning of the computer-implemented services over time.

20. The data processing system of claim 19, wherein making the determination comprises:
monitoring operation of at least a portion of the service systems leading up to the future point in time;
comparing the operation to the prediction to identify a level of accuracy of the prediction; and
in an instance of the comparing where the level of accuracy meets criteria:
identifying that a current time is within a threshold duration of time to the future point in time.
